(19) United States
(12) Patent Application Publication
(10) Pub. No.: US 2016/0309738 A1
(43) Pub. Date: Oct. 27, 2016

(54) MOULDING TOOL FOR FROZEN CONFECTION

(71) Applicant: CONOPCO, INC., D/B/A/ UNILEVER, Englewood Cliffs, NJ (US)

(72) Inventors: Paul Edward CHENEY, Peterborough (GB); Sakchai KLINHOM, Bangkok (TH); Visit MANOPAKARAT, Bangkok (TH)

(73) Assignee: Conopco, Inc., d/b/a UNILEVER, Englewood Cliffs, NJ (US)

(21) Appl. No.: 15/102,901

(22) PCT Filed: Nov. 21, 2014
(86) PCT No.: PCT/EP2014/075282

§ 371 Date: Jun. 9, 2016

(30) Foreign Application Priority Data
Dec. 13, 2013 (EP) 13197079.0

(51) Int. Cl. A23G 9/08; A23G 9/22; A23G 9/48; A23G 9/24; A23G 9/26

(52) U.S. Cl. CPC A23G 9/083; A23G 9/245; A23G 9/26; A23G 9/48; A23G 9/221

(57) ABSTRACT

The present invention is in the field of ice cream shaping, in particular it is relating to a mould for a frozen confectionery, suitable for creating a peelable frozen confectionery product. The present invention further relates to a shaped frozen confectionery product. There is still a need for an easy and effective mould that is suitable for making a peelable frozen confectionary product in a single mould without the need for a separate tool or device for making peeling lines, groves or other cuts. It is an object of the present invention to provide a mould for a frozen confectionery product that that makes grooves in the outer layer of a frozen confectionery products, especially peelable frozen confectionery products. We have found that a mould for frozen confectionery products comprising at least one inwardly protruding ridge, provides a tear line on peelable ice-cream made by said mould.

### FIELD OF THE INVENTION

The present invention is in the field of ice cream shaping, in particular it is relating to a mould for a frozen confectionery, suitable for creating a peelable frozen confectionery product. The present invention further relates to a shaped frozen confectionery product.

### BACKGROUND OF THE INVENTION

Consumers (especially children) are always looking for frozen confectionery products which provide interesting eating experiences. Products that provide a new shape or appearance are always appreciated. However, it is a constant challenge in the art to find new ways to shape frozen confectionery products.

Products consisting of a core of frozen confection with a jelly-like coating have been known for some years, for example as described in WO01/30175 and U.S. Pat. No. 3,752,678. CN 101120714A discloses a variation on this in which the jelly coating can be peeled off the frozen confection core, in a manner similar to that of peeling the skin off a piece of fruit. However, it can be difficult to peel the jelly coating away from the frozen confection core without part of the coating sticking to the core and/or the coating breaking up into small pieces.

Similarly, frozen confectionery consisting of an inner core of one confection and an outer shell of another confectionery such as a gel have been proposed before. Alternatively the “twister” ice cream by Unilever is a popular example of a frozen confectionery product having distinct confectionery types in a product.

A more recent example of frozen confectionery products with distinct phases are frozen confectionery products comprising of an inner core of typically ice cream or water ice and an outer layer of gel that can be peeled off the core. One example for such a peelable frozen confectionery product is disclosed in WO2012/156539 and WO2012/156538 (NESTEC S.A.). This type of process first requires a mould for making a frozen confectionery product and then a second mould for shaping the product; the second mould being a cutting or shaping mould. This adds complexity to the process and a single moulding process for making a peelable frozen confectionery remains to be desired. Another drawback of this system is that the cutting depth needs to be controlled very well and the process requires high precision equipment to ascertain the correct alignment of the product before cutting, which again adds complexity to the process.

The cutting lines in peelable frozen confectionery products as proposed in the art that are currently made by knives on moulds can leave distorted edges on the frozen confectionery product, especially on the sides of the product where typically two mould with knives meet the cuts show distorted material around the cutting line. Incorrect of poorly aligned cuts result into products that cannot be easily peeled by the consumer.

One way of avoiding coarse looking cutting lines is the use of a shaping tool that melts away some frozen confection in order to make a more appealing line, such as disclosed in our co-pending application PCT/CN2013/084058.

However there is still a need for an easy and effective mould that is suitable for making a peelable frozen confectionary product in a single mould without the need for a separate tool or device for making peeling lines, groves or other cuts.

It is therefore an object of the present invention to provide a mould for a frozen confectionery product that that makes grooves in the outer layer of a frozen confectionery products, especially peelable frozen confectionery products.

It is a further object of the invention that the mould provides improved peeling of a frozen confectionery product.

It is still a further object of the invention that the mould provides a distinct peeling line in or on the surface of the frozen confection.

It is yet another object to provide a mould for making a peelable frozen confectionery product that comprises of a core and a shell layer, the mould being suitable for making a clearly distinguishable peeling line in or through the shell layer of the product.

Surprisingly it is found that A mould for frozen confectionery products comprising at least one inwardly protruding ridge, provides a tear line on peelable ice-cream made by said mould.

### SUMMARY OF THE INVENTION

Accordingly, in a first aspect a process for shaping a frozen confectionery product comprising the steps of either: filling the mould comprising a container having a closed bottom section, an open top section, and a middle section; the middle section comprising at least one inwardly protruding ridge with a first composition, comprising a gelling agent, leaving the composition to solidify against the wall of the container until at least 1 mm has solidified against the wall, emptying remaining material from the mould, filling the mould with a second composition, leaving the material to solidify completely, and removing the solidified product from the mould; or: filling the mould comprising a container having a closed bottom section, an open top section, and a middle section; the middle section comprising at least one inwardly protruding ridge with a first composition, comprising a gelling agent, inserting a counter mould, leaving the composition to solidify against the wall of the container until at least 1 mm has solidified against the wall, removing the counter mould, filling the mould with a second composition, leaving the material to solidify completely, and removing the solidified product from the mould; or: filling the mould comprising a container having a closed bottom section, an open top section, and a middle section; the middle section comprising at least one inwardly protruding ridge with a first composition, comprising a gelling agent, inserting a pre-formed frozen core, leaving the material to solidify completely, and removing the solidified product from the mould characterised in that the first composition comprises a gelling agent.

By “peelable” is meant that an outer layer of the confectionery product may be removed by hand.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### BRIEF DESCRIPTION OF THE FIGURES

The figures show embodiments of the mould for providing a shaped confectionery product. However the invention is by no means limited to those shapes only.

FIG. 1 shows an embodiment of single mould.

FIG. 2 shows an embodiment of a set of 4 moulds.

FIG. 3 shows an improved filling nozzle for the mould.

### DETAILED DESCRIPTION OF THE INVENTION

Accordingly, the invention provides a mould for frozen confectionery products comprising a container having a closed bottom section, an open top section, and a middle section; the middle section being tapered such that the circumference of the of the middle section at the point where it meets the bottom section is at least 0.5% less than the circumference at the top of the middle section; the middle section comprising at least one inwardly protruding ridge.

The mould is preferably tapered to allow for easier removal of the frozen confection after moulding. The tapering of the middle section preferably being tapered such that the circumference of the of the middle section at the point where it meets the bottom section is at least 0.5% less than the circumference at the top of the middle section, preferably at least 1%, more preferably at least 2%, still more preferably at least 3%, or even at least 5%, but typically less than 50%, more preferably not more than 40%, still more preferably not more than 30%, even more preferably not more than 20%, even still more preferably not more than 10% or even not more than 6%.

The mould may be made from any commonly used material. The mould is preferably made of food safe materials. Preferred materials are metals, ceramic materials and plastics, such as low density or high density polyethylene. Preferred metals include, but are not limited to, metals and alloys such as stainless steel, brass, aluminium, titanium.

The total volume of the container is preferably between 10 and 200 ml, more preferably at least 20 ml, still more preferably at least 30 ml, or even at least 40 ml, while the container is preferably not more than 180 ml, still more preferably not more than 160 ml, or even not more than 140 ml.

Ridge

The ridge is preferably comprising of 2 sides, the sides preferably being joined together at an angle of not more than 120° in the middle and the other outer edges of the sides being joined to the container wall; preferable not more than 90° or even not more than 75°.

For the avoidance of doubt, the ridge comprises of 2 sides, each side being in the shape of a strip, each strip having to long sides and 2 short sides. Two of the long sides are joined together at the angle as mentioned above. The short sides on the top end of the middle section are open; the short sides at the bottom are connected to the bottom section.

Ideally the ridge forms an integral part of the container wall, but embodiments where the ridge is joined with the outer wall of the middle section are not excluded from the scope of the invention; this further includes solidly filled ridges. In a preferred embodiment the ridge is part of the container wall; especially when the outer wall of the mould is briefly heated prior to de-moulding the frozen confectionery from the mould.

In a preferred embodiment the ridge extends from the top of the opening of the container all the way the bottom of the container. In the case of more than one ridge being used, this results in the ridges being joined together in the bottom section of the container.

The ridge typically protrudes inwardly for at least 1 mm. By protruding inwardly is meant protruding from the container wall inwardly, preferably towards the centre axis the container. The ridge is preferably protruding inwardly at least 1.5 mm, more preferably at least 2 mm, still more preferably 2.5 mm, or even at least 3 mm; but typically not more than 10 mm, more preferably not more than 8 mm, still more preferably not more than 6 mm.

The mould may contain more than one ridge. Preferably the mould according to the invention comprises at least 2 ridges, preferably at least 3 ridges, more preferably at least 4 ridges, but typically not more than 10 ridges, still more preferably not more than 8 ridges, or even not more than 6 ridges.

Shape

The mould may be a single piece, but a mould comprising two halves or more parts that are connected together is also contemplated in the scope of the invention.

When the mould is a single piece the shape is limited. In the most basic operation a single piece mould provided with lengthwise ridges, generally provides a banana type peelable frozen confectionery, due to the limitations of demoulding. However, a single piece mould with spiral ridges and a system that turns the confectionery during demoulding could still provide a spiral peel on the confectionery product.

However, when the mould comprises of more parts that are held together during moulding, different shapes are also possible, including a spiral peel, as the mould can be opened into two or more parts for demoulding then. In the case of moulds comprising of more than one part, the mould does not require tapering for easier demoulding, but can be any shape.

Process

In another aspect, the invention further provides a process for shaping a frozen confectionery product comprising the steps of: cooling the mould according to the invention, filling the mould with a first composition, leaving the composition to solidify against the wall of the container until at least 1 mm has solidified against the wall, emptying remaining material from the mould, filling the mould with a second composition, and leaving the material to solidify completely, and removing the solidified product from the mould.

Outer Layer

The outer layer is prepared by filling the mould with a composition for the outer layer of the frozen confectionery product. The mould may be cooled down before filling with the composition of the outer layer or after or both, preferably the mould is cooled down before the outer layer composition is added and is continuously cooled during the whole process until the confectionery of solidified. The outer layer composition then solidified against the outer wall of the container. Ideally the layer is at least 1 mm thick, preferably at least 2 mm, or even at least 3 mm thick, but preferably not more than 10 mm, more preferably not more than 8 mm, still more preferably not more than 5 mm. In a preferred embodiment the outer layer has a thickness that is the same as the depth of the ridge, plus or minus 50%, more preferably plus or minus 30%, still more preferably plus or minus 20%, even more preferably plus or minus 10%.

Without wishing to be bound to a theory, we have found that this way of filling mould with the composition of the outer layer and letting it solidify against the outer wall, yields an outer layer that has a substantially homogeneous thickness in the parts between the ridge, but has a substantially lesser thickness over the ridges. Again without wishing to be bound by a theory, it is thought that this reduced thickness provides for the easier peelability.

When the outer layer is thick enough, the remaining liquid composition is removed from the mould. This may be done by sucking the remaining liquid out, or by turning the mould upside down. Other conventional ways of removing excess liquid from the mould are also contemplated.

Alternatively, the outer layer may be produced by at least partially filling the mould with the liquid outer layer composition, and inserting a counter mould inside the mould according to the invention, thereby displacing the outer layer composition such that it fills the space between the mould of the invention and the counter mould. The counter mould would then be left in place until the outer layer is frozen. By partially filling is meant filling with an amount of outer layer composition suitable for forming a outer layer.

The use of a pre-formed frozen core material as counter mould is also contemplated. In that case, the core acting as counter mould need not be removed after freezing the core.

Filling Nozzle

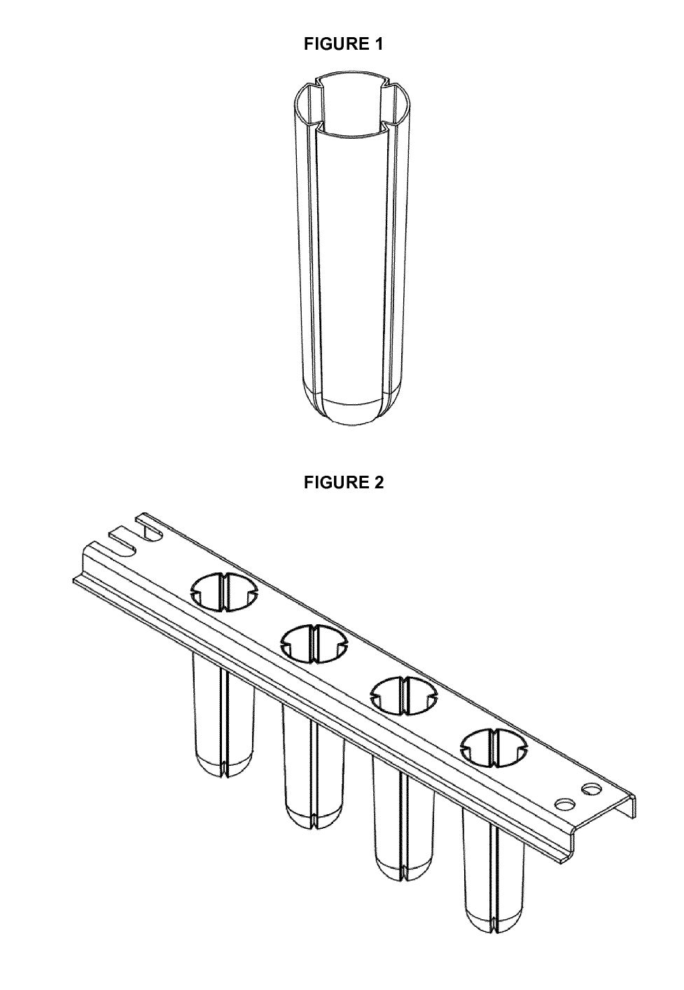

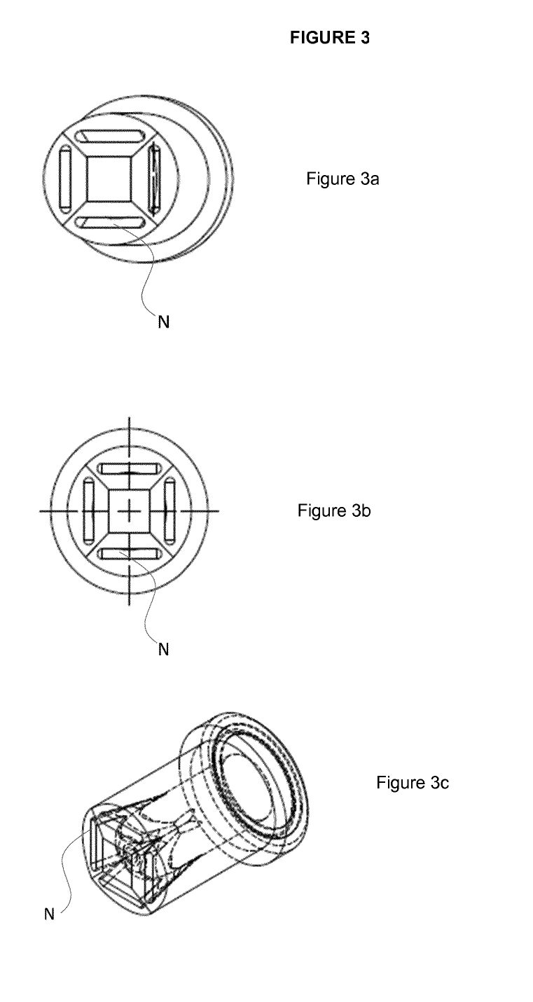

In a preferred embodiment the mould may be filled by an improved nozzle that comprises multiple outlets. Ideally the number of outlets corresponds with the number of ridges. The outlets of the nozzle, while in operation, are ideally aimed towards the sections between the ridges of the container. One embodiment of such a nozzle is depicted in FIG. 3. The filling nozzle of FIG. 3, comprises 4 exit nozzles to match the 4 sections of FIG. 1. Nozzles assemblies with a different number of exit nozzles to match with a different number of section in a mould, are also contemplated. The nozzle may comprise between 3 and 8 exit nozzles, typically between 3 and 5.

This improved nozzle is ideally used for filling the mould with the outer layer composition.

However, the mould of the invention may also be filled with conventional filling nozzles.

Core

Now the core composition is added to the mould. The core composition is preferably pre-cooled to avoid that the outer layer is dissolved when the core composition is added. The core composition is preferably cooled to a temperature of less than 15° C., more preferably not more than 10° C., still more preferably nor more than 5° C., even more preferably below 2° C., or even below 1° C.

The core composition is then left to solidify inside the mould.

A stick may be added before the core composition is solidified or after, or at any time between adding the core composition to the mould and completion of the solidification.

Demoulding

Prior to demoulding the mould is briefly heated. Without wishing to be bound by a theory it is thought that heating the mould prior to demoulding may cause the mould to slightly expand, making demoulding easier, and/or melt an outer film of the frozen confectionery product that allows for easier removal of the product. Ideally the mould is heated for at least 1 second, preferably at least 2 seconds, or even at least 5 seconds, but typically less than a minute.

The heating may be done in any conventional may, for instance, the mould may be placed in a hot aqueous solution or the mould may be heated by a water jacket, or even by electricity. When heated with water, the water is preferably at least 5° C., more preferably at least 10° C., still more preferably at least 15° C., or even at least 20° C., but preferably less than 100° C., more preferably not more than 80° C., still more preferably not more than 70° C., or even not more than 60° C. or even not more than 50° C.

Frozen Confection

The frozen confection according to the present invention comprises a core comprising conventional frozen confection and an outer layer (shell) of a gel layer

Unless defined otherwise, all technical and scientific terms used herein have the same meaning as commonly understood by one of ordinary skill in the art (e.g. in frozen food manufacture). Definitions and descriptions of various terms and techniques used in frozen confectionery manufacture are found in “Ice Cream”, 6th Edition R. T. Marshall, H. D. Goff and R. W. Hartel, Kluwer Academic/Plenum Publishers, New York 2003 and “The Science of Ice Cream”, C. J. Clarke, Royal Society of Chemistry, Cambridge, 2004.

Core

Frozen confections are sweet-tasting fabricated foodstuffs intended for consumption in the frozen state (i.e. under conditions wherein the temperature of the foodstuff is less than 0° C., and preferably under conditions wherein the foodstuff comprises a significant amount of ice). Frozen confections include water ices and fruit ices, which comprise water and one or more of sugars, stabilisers, colours and flavours, but little or no fat or protein (e.g. less than 5 wt % of each, preferably less than 2 wt %). Frozen confections also include ice creams, frozen yoghurts, sorbets and the like.

Shell

The core of the frozen confection may be partially or completely covered with a layer of a gel. It is preferred that at least the top and the sides are covered, but preferably also the bottom of the product. The product may be produced for example by coating a preformed frozen confection core with a gel layer which is applied by dipping, spraying, or enrobing; or by means of a fill and suck process in a mould wherein a gel mix is filled into a mould, the core sucked out and then re-filled with frozen confection. In a preferred embodiment, the core is substantially covered by a layer of gel, and scores or notches are present in the gel layer. The scores/notches allow easy peeling of strips of the gel layer, for example in a similar manner to peeling a banana or a spiral peel. The scores/notches may be formed for example by cutting the gel layer after it has been formed, or, when the fill and suck method is used, by using a mould with suitable indentations.

The gel layer may be formed from a mix which contains a gelling agent. The gelling agent may be a thermoreversible gelling biopolymer such as gelatine or agar.

Alternatively the gelling agent may be a chemically setting gelling biopolymer which derives its gel structure from an interaction between the biopolymer and an appropriate ion such as Ca2+. Examples include sodium alginate, iota-carrageenan, kappa-carrageenan and pectin. The gelling agent could also be a synergistic combination of two or more biopolymers that may be individually non-gelling, but on mixing will form a gel or a gel of a higher modulus. Examples include: sodium alginate with pectin, xanthan with locust bean gum, agar with locust bean gum, and kappa carrageenan with locust bean gum. The gelling agent is present in an amount such that the gel is sufficiently strong to for the gel layer to cohere so that it does not break apart too easily during peeling. The gel strength can be increased by increasing the amount of the gelling agent in the mix.

The gel may be formed by lowering the temperature (for thermally setting gelling agents) or by combining two separate mix streams, each of which contains one of the components of a chemically setting gelling agent. For example, the mix may be made in two parts, one containing sodium alginate and the other containing a source of Ca2+ ions. When the two mixes are combined in the mould, the alginate reacts with the Ca2+ to form the gel.

Peel

The frozen confectionery product according to the present invention preferably comprises a core of frozen confection and a gel outer layer; wherein the gel layer comprises an indentation caused by the ridges of the mould.

Preferably the product comprises notches for easier peeling.

The peel experience of the product according to the invention is more intense due to the clearer peel lines and the easier peeling and more appealing appearance caused by the indentation.

### DETAILED DESCRIPTION OF THE FIGURES

The figures show embodiments of the mould.

FIG. 1 shows a single mould. The mould is made as a single piece and has 4 ridges on the side, protruding inwardly towards the centre of the mould and runs over the full length of the mould.

FIG. 2 shows a set of 4 moulds. The 4 moulds are joined together at the top end.

FIG. 3 shows a filling nozzle assembly for filling the mould of the invention. FIG. 3a shows a perspective view of the exit part of the nozzle, comprising 4 exit nozzles (N). FIG. 3b shows a direct front view of the same nozzle, again having 4 exit nozzles (N). FIG. 3c is a see through perspective from the filling side of the filling nozzle.

### EXAMPLES

### Example 1

### Preparing Banana Peel Ice Cream Ridged Mould

The product of this example comprises of an ice cream core and peelable layer of a frozen jelly.

Ice Cream Core Ingredients and Preparation of the Composition

Sugars 14%

Skimmed milk powder 5%

Coconut oil 4%

Corn syrup 10%

Flavour and colour 0.12%

Stabilizer 0.3%

Water 62.58%

The ice-cream core composition was prepared as follows. The water was heated to 60° C. Then sugar, stabilizer, milk powder, whey powder and oil were slowly added to the tank under agitation to ensure even dispersion of these ingredients. The resulting mixture was pasteurized at 70° C. for 20 minutes and homogenised before cooling down the composition to 4° C. and age for 24 h.

Shell Ingredients (Jelly) and Preparation of the Jelly Composition

Sugars 27%

Corn syrup 40DE 15%

Fruit juice 2%

Gums 0.6%

Citrate acid 0.5%

Flavour and colour 0.12%

Water 54.78%

The Jelly composition (outer layer) was prepared by heating the water to 85° C. and adding part of the sugar and the stabilizer at the ratio of 10:1. The mixture was then mixed for 2 minutes, before adding the remaining sugars and syrups. This mixture was stirred for 10 minutes. The other (minor) ingredients (citric acid, sodium citrate, etc. except the flavour ingredient) were added, followed by the colour ingredient. This composition was stirred at 65° C. for 2 minutes and pasteurized at 81° C. for 30 sec. Then the flavour was added after pasteurization.

The frozen confectionery product was made by pouring 51 ml of liquid jelly composition (at 55° C.) into a frozen mould according to the invention. The Jelly was given time to freeze against the mould walls, to form a jelly layer of approximately 3 mm before sucking out the excess liquid jelly composition. This forms the jelly layer shell. The liquid ice-cream composition of the core was added inside the jelly core and frozen in the mould. A stick was inserted and the layered ice-cream product was demoulded.

The products were provided with nicely formed indentations cause by the ridged mould and provided for excellent and easy peelability of the product.

1. A process for shaping a frozen confectionery product comprising a core of frozen confection and a gel outer layer; wherein the gel layer comprises an indentation caused by ridges of a mould; the process comprising the steps of either:
a. Filling the mould comprising a container having a closed bottom section, an open top section, and a middle section; the middle section comprising at least one inwardly protruding ridge with a first composition, comprising a gelling agent,
b. Leaving the composition to solidify against the wall of the container until at least 1 mm has solidified against the wall,
c. Emptying remaining material from the mould,
d. Filling the mould with a second composition,
e. Leaving the material to solidify completely, and
f. Removing the solidified product from the mould; or:
a. Filling the mould comprising a container having a closed bottom section, an open top section, and a middle section; the middle section comprising at least one inwardly protruding ridge with a first composition, comprising a gelling agent,
b. Inserting a counter mould
c. Leaving the composition to solidify against the wall of the container until at least 1 mm has solidified against the wall,
d. Removing the counter mould
e. Filling the mould with a second composition,
f. Leaving the material to solidify completely, and
g. Removing the solidified product from the mould; or:
a. Filling the mould comprising a container having a closed bottom section, an open top section, and a middle section; the middle section comprising at least one inwardly protruding ridge with a first composition, comprising a gelling agent,
b. Inserting a pre-formed frozen core,
c. Leaving the material to solidify completely, and
d. Removing the solidified product from the mould characterised in that the first composition comprises a gelling agent.

2. A process according to claim 1, wherein the mould is cooled down before step (a), after step (a), or both.

3. A process according to claim 1, wherein the first composition is filled into the mould with a nozzle that comprising multiple outlets

4. A process according to claim 3, wherein the number of outlets of the nozzle corresponds with the number of ridges of the mould; and wherein the outlets of the nozzle, while in operation, are aimed towards the sections between the ridges of the container.

5. A process according to claim 1, wherein the mould is heated to a temperature of at least 20° C. more than the temperature of the solidified product for at least 1 second.

6. A process according to claim 1, wherein in the mould the middle section is tapered, such that the circumference of the middle section at the point where it meets the bottom section is at least 0.5% less than the circumference at the top of the middle section.

7. A process according to claim 1, wherein in the mould the ridge is comprising 2 sides, the sides being joined together at an angle of not more than 120° in the middle and the other outer edges of the sides being joined to the container wall;

8. A process according to claim 1, wherein in the mould the ridge is part of the container wall.

9. A process according to claim 1, wherein in the mould the ridge protrudes inwardly for at least 1 mm.

10. A process according to claim 1, wherein mould compromises at least 2 ridges, preferably at least 3 ridges, more preferably at least 4 ridges.

11. A process according to claim 1, wherein the gelling agent may be a thermoreversible gelling biopolymer or a chemically setting gelling biopolymer or mixtures thereof.

12. A process according to claim 11, wherein the gelling agent is a thermoreversible gelling biopolymer selected from gelatine or agar

13. A process according claim 11, wherein the gelling agent is a chemically setting gelling biopolymer selected from a sodium alginate, iota-carrageenan, kappa-carrageenan and pectin.
